(19) United States
(12) Patent Application Publication
(10) Pub. No.: US 2015/0205426 A1
(43) Pub. Date: Jul. 23, 2015

(54) CONTROLLING ACTIVE INPUT AREAS OF A TOUCH SENSITIVE SURFACE

(71) Applicant: Lenovo (Singapore) Pte. Ltd., Singapore (SG)

(72) Inventors: Vincent Charles Conzola, Raleigh, NC (US); Ali Kathryn Ent, Garner, NC (US); Cuong Huy Truong, Cary, NC (US); Wesley Abram Luttrell, Raleigh, NC (US)

(73) Assignee: Lenovo (Singapore) Pte. Ltd., Singapore (SG)

(21) Appl. No.: 14/161,116

(22) Filed: Jan. 22, 2014

(51) Int. Cl. G06F 3/041; G06F 3/0488

(52) U.S. Cl. CPC G06F 3/0416; G06F 3/0412; G06F 3/04886

(57) ABSTRACT

An aspect provides a method, including: activating, using a processor, a touch sensitive surface; accepting user inputs to the touch sensitive surface; detecting, using a processor, a deactivation event; and deactivating, using a processor, a portion of the touch sensitive surface such that the portion is unresponsive to touch input following detection of the deactivation event; wherein the deactivating deactivates one or more portions of the touch sensitive surface for one or more users; and wherein at least one other portion of the touch sensitive surface remains active. Other aspects are described and claimed.

### BACKGROUND

Information handling devices (“devices”) come in a variety of forms, for example desktop or laptop computing devices, tablet computing devices, smart phones, and the like. Device users are increasingly relying on touch sensitive surfaces, e.g., a touch screen, to provide inputs, e.g., controlling inputs such as scrolling, or content inputs, such as providing handwriting inputs, etc. With advances in technology, even multiple users may provide simultaneous inputs to touch sensitive surfaces, e.g., while interfacing with larger touch screens to play a game, work on a project document, etc.

### BRIEF SUMMARY

In summary, one aspect provides a method, comprising: activating, using a processor, a touch sensitive surface; accepting user inputs to the touch sensitive surface; detecting, using a processor, a deactivation event; and deactivating, using a processor, a portion of the touch sensitive surface such that the portion is unresponsive to touch input following detection of the deactivation event; wherein the deactivating deactivates one or more portions of the touch sensitive surface for one or more users; and wherein at least one other portion of the touch sensitive surface remains active.

Another aspect provides an information handling device, comprising: a touch sensitive surface; a processor operatively coupled to the touch sensitive surface; a memory device that stores instructions accessible to the processor, the instructions being executable by the processor to: activate the touch sensitive surface; accept user inputs to the touch sensitive surface; detect a deactivation event; and deactivate a portion of the touch sensitive surface such that the portion is unresponsive to touch input following detection of the deactivation event; wherein to deactivate comprises deactivating one or more portions of the touch sensitive surface for one or more users; and wherein at least one other portion of the touch sensitive surface remains active.

A further aspect provides a product, comprising: a storage device having code stored therewith, the code being executable by a processor and comprising: code that activates, using a processor, a touch sensitive surface; code that accepts user inputs to the touch sensitive surface; code that detects, using a processor, a deactivation event; and code that deactivates, using a processor, a portion of the touch sensitive surface such that the portion is unresponsive to touch input following detection of the deactivation event; wherein the code that deactivates further deactivates one or more portions of the touch sensitive surface for one or more users; and wherein at least one other portion of the touch sensitive surface remains active.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example of controlling active area of a touch sensitive surface.

FIG. 4 illustrates an example of active and inactive areas of a touch sensitive surface.

FIG. 5(A-B) illustrates further examples of active and inactive areas on a touch sensitive surface.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

When using a touch screen device one problem that sometimes occurs is inadvertent touches are registered, e.g., when the user accidentally makes contact with the screen in an area he or she did not intend to touch. This often happens when using a stylus or finger to draw on the screen and the palm of the hand rests on the touch screen. With newer multi-touch touch screens this also occurs is when multiple people are sharing a large screen device and one user accidentally touches the screen when a different user is trying to accomplish a task. In such situations, it would be advantageous from a user experience standpoint for the user to be able to deactivate areas of the touch screen where he or she does not want touches to register.

Currently there exists software that is able to distinguish between different types of touches, e.g., a finger touch and a palm resting on the touch screen surface. Such palm rejection software is common in certain touch screen products. There also exist software solutions that allow a user to disable the touch function for the entire screen at any given time. What is missing is a simple way for a user to control specific areas of a touch screen and temporarily designate them as either active or inactive.

Accordingly, an embodiment provides a touch sensitive surface, e.g., a touch screen, which may be partially deactivated. For example, a user may deactivate a portion of the touch screen via providing inputs to delimit area(s) of the touch screen that are to be deactivated. Similarly, an embodiment may facilitate use of touch screen in a multi-user environment, e.g., via permitting the assignment of area(s) to specific users, whereas touch inputs outside of assigned areas will not register as inputs. It should be noted that although the term “deactivate” (or “inactivate”) is used throughout, this does not necessarily mean that the touch sensitive surface is no longer active at all or no longer active from the perspective of sensing touch inputs. Rather, an embodiment may filter touch inputs that are sensed in a deactivated area, e.g., filtering out touch inputs to the deactivated area.

The illustrated example embodiments will be best understood by reference to the figures. The following description is intended only by way of example, and simply illustrates certain example embodiments.

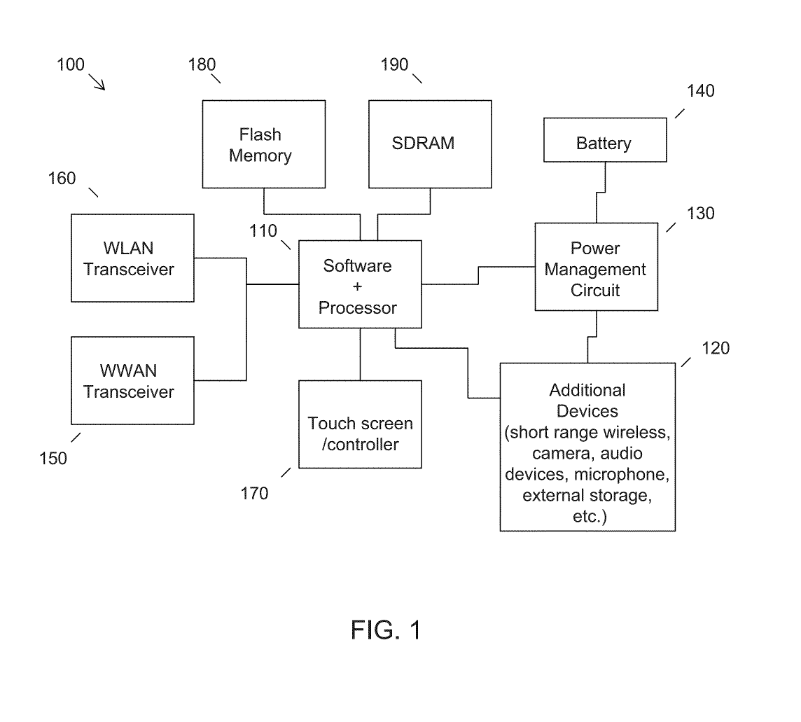

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additional devices 120 are commonly included. System 100 often includes a touch screen 170 for data input and display/rendering, e.g., receiving content and navigation inputs via a pen or stylus, as further described herein. System 100 also typically includes various memory devices, for example flash memory 180 and SDRAM 190.

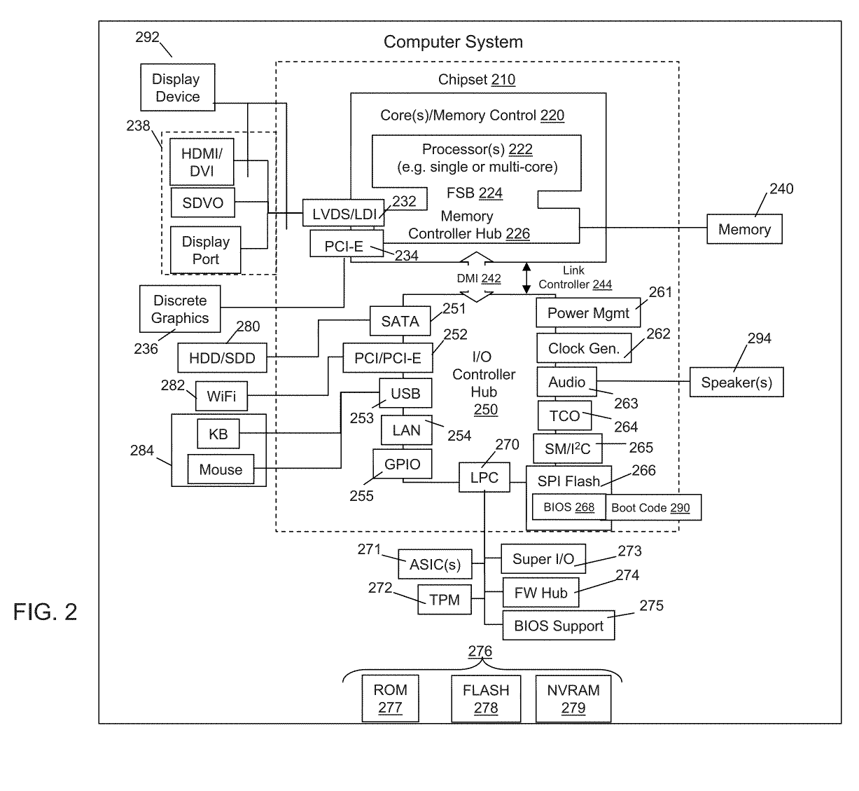

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a LVDS interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be included in user devices that accept inputs to a touch sensitive surface such as a touch screen. An embodiment provides a user with the ability to selectively deactivate certain portions or areas of the touch screen using a variety of modalities, as described further herein. In an embodiment, rather than deactivating an entire touch screen, those area(s) not deactivated remain active and responsive to user touch inputs. The deactivated portions may be visible, e.g., continue to display content, and may also include an indication of the deactivation, e.g., a visual indication such as a slightly grayed out area.

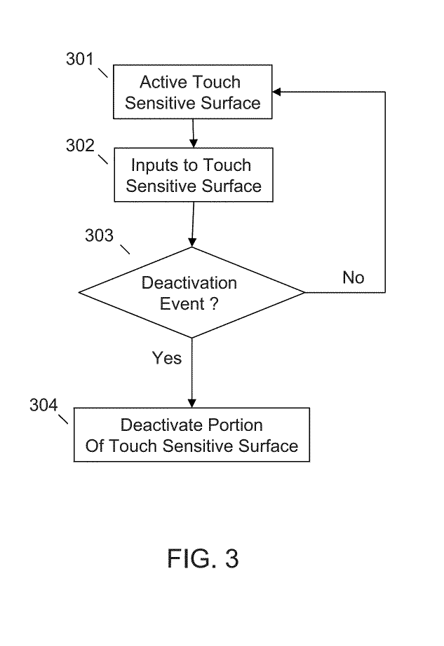

Referring to FIG. 3, an embodiment provides an active touch sensitive surface such as a touch screen at 301. The touch sensitive surface may thus accept user inputs to the touch sensitive surface in all areas at 302. An embodiment may thereafter detect a deactivation event at 303, e.g., a user supplied deactivation event such as a user selection of a portion of the touch sensitive surface for deactivation or a user specific designation event, e.g., that assigns portions of the touch sensitive surface to different users. If such a deactivation event is detected at 303, an embodiment may thereafter deactivate the portion(s) of the touch sensitive surface at 304, e.g., corresponding to the parameters of the deactivation event.

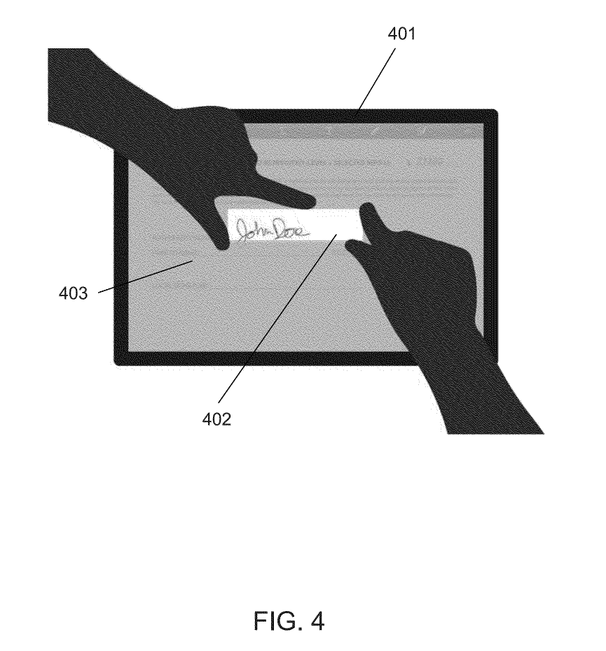

For example, an embodiment permits a user to create an active touch area and a deactivated touch area, for example by detecting that the user has formed a virtual bezel. As illustrated in FIG. 4 by way of example, an embodiment may detect that the user has placed his or her fingers on or near the inactive bezel 401 of the screen, then has slid the fingers inwards from both directions, essentially moving the inactive bezel 401 inwards to create a box 402 around the area they wish to remain active and delimiting the area 403 that they wish to deactivate.

This active box 402 continues to accept user inputs and may be moved around the screen. The dimensions of the active box 402 may be changed, e.g., by simply touching the edges of the box 402 and dragging in or out accordingly, e.g., similar to moving a virtual bezel. An embodiment thus provides the ability to edit the placement and dimensions of the active area. As illustrated in FIG. 4, the inactive or deactivated area 403 may continue to render displayed content, with or without a visual indication, as illustrated.

A user may remove the inactive area 403 by providing an activation event, e.g., via grabbing the horizontal and vertical edges of the active area 402 and “throwing” them outward (or providing another predetermined gesture or input) to make the entire screen active again.

For text-specific fields within an active area 402, a double-tap on the field may activate that particular text field (and only that field) for input by the user. Double-tapping on another text field may move the focus and ability to edit to the next field, leaving the previous field inactive once again. An embodiment also provides an ability to control designated active 402 and inactive 403 areas with a timer function. For example, a user may provide a deactivation event that includes timing such that a designated area will only be touch-active at certain times. This capability may be useful for example in a school setting where timed exams administered on touch screen devices need to deactivate the entire screen or designated areas of the screen from receiving touch input once a pre-set time limit expires.

As described herein, the deactivation event may comprise a user specific designation event. For example, user-specific (including stylus/pen-specific) restrictions in applications like games, etc., may be utilized. For example, a user-specific designation may be utilized such that user A may only interact with certain areas or objects on the screen (e.g., user A game pieces in a chess game, as an example), but cannot edit or manipulate user B's pieces.

Other possible applications of utilizing user specific designations may include but are not necessarily limited to designating areas in formatted documents, e.g., legal documents that require digital signatures, use in games or drawing programs where multiple users would be touching the screen at the same time, or drawing programs where it is often necessary for a user to rest his or her fingers or palm on the screen for added precision.

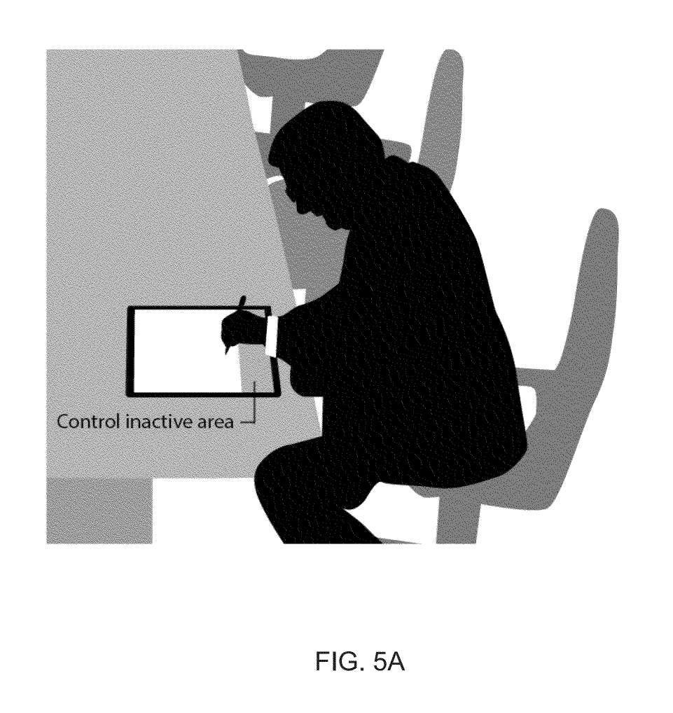

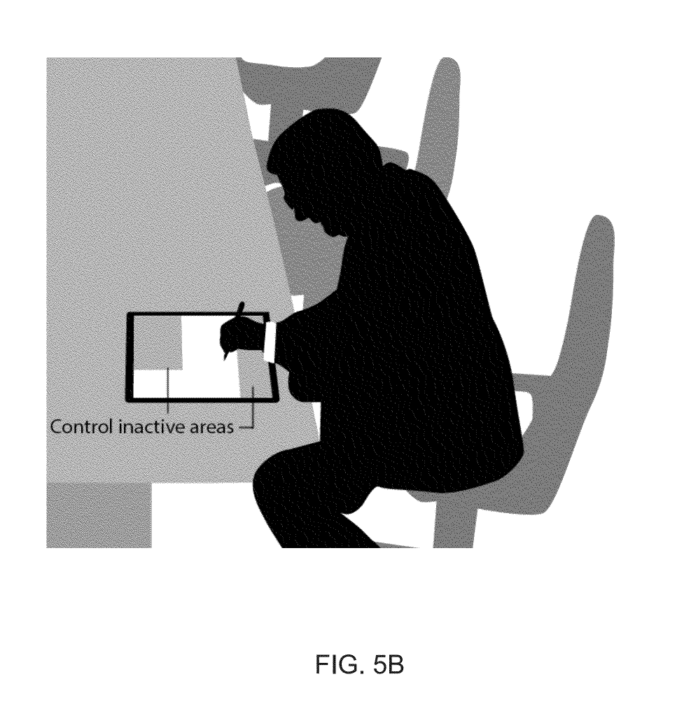

By way of example, FIG. 5(A-B) illustrates examples of inactive and active areas of a touch sensitive surface. In FIG. 5A a user has extended a virtual bezel upwards, e.g., using a gesture input mapped to virtual bezel movement, such that the lower portion of the touch input surface has been inactivated (in terms of accepting control inputs). Likewise, illustrated in FIG. 5B is a touch sensitive surface in which a user has extended a virtual bezel upwards, e.g., using a gesture input mapped to virtual bezel movement, and has extended a virtual bezel from the upper right corner of the touch sensitive surface, forming two inactivated areas (in terms of accepting control inputs).

Accordingly, an embodiment permits a user to deactivate certain areas within a touch sensitive surface while continuing to utilize other active areas of the touch sensitive surface. While specific examples have been provided herein, it will be appreciated by one having ordinary skill in the art that more than one active/inactive designation may be utilized, more than one active and more than one inactive area formed, as well as providing user specific designation or assignments to particular areas. The adjustment of the active area(s) of the touch sensitive surface furthermore may not be static, but dynamic such that areas may switch from active to inactive and vice versa, e.g., responsive to user inputs, underlying application events, etc.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
activating, using a processor, a touch sensitive surface;
accepting user inputs to the touch sensitive surface;
detecting, using a processor, a deactivation event; and
deactivating, using a processor, a portion of the touch sensitive surface such that the portion is unresponsive to touch input following detection of the deactivation event;
wherein the deactivating deactivates one or more portions of the touch sensitive surface for one or more users; and
wherein at least one other portion of the touch sensitive surface remains active.

2. The method of claim 1, wherein said deactivating comprises deactivating responsive to a user supplied deactivation event that selects a portion of the touch sensitive surface for deactivation.

3. The method of claim 1, wherein the detecting comprises detecting a user supplied deactivation event, the detected user supplied deactivation event comprising user gesture input to the touch sensitive surface delimiting a portion of the touch sensitive surface for deactivation.

4. The method of claim 3, wherein the detecting a user gesture input comprises detecting a virtual bezel movement.

5. The method of claim 4, wherein the detecting user gesture input comprises detecting multi-touch virtual bezel movement.

6. The method of claim 1, further comprising providing a visual indication of the portion of the touch sensitive surface that has been deactivated.

7. The method of claim 6, wherein the portion of the touch sensitive surface that has been deactivated continues to display content.

8. The method of claim 1, wherein the detecting comprises detecting user supplied timing information relating to deactivation.

9. The method of claim 1, wherein the detecting comprises detecting assignments for two or more users for different touch input areas of the touch sensitive surface.

10. The method of claim 9, wherein the deactivating comprises disregarding user specific touch inputs to an area of the touch sensitive surface not assigned to a specific user.

11. An information handling device, comprising:
a touch sensitive surface;
a processor operatively coupled to the touch sensitive surface;
a memory device that stores instructions accessible to the processor, the instructions being executable by the processor to:
activate the touch sensitive surface;
accept user inputs to the touch sensitive surface;
detect a deactivation event; and
deactivate a portion of the touch sensitive surface such that the portion is unresponsive to touch input following detection of the deactivation event;
wherein to deactivate comprises deactivating one or more portions of the touch sensitive surface for one or more users; and
wherein at least one other portion of the touch sensitive surface remains active.

12. The information handling device of claim 11, wherein to deactivate comprises deactivating responsive to a user supplied deactivation event that selects a portion of the touch sensitive surface for deactivation.

13. The information handling device of claim 11, wherein to detect comprises detecting a user supplied deactivation event, the detected user supplied deactivation event comprising user gesture input to the touch sensitive surface delimiting a portion of the touch sensitive surface for deactivation.

14. The information handling device of claim 13, wherein the detecting a user gesture input comprises detecting a virtual bezel movement.

15. The information handling device of claim 14, wherein the detecting user gesture input comprises detecting multi-touch virtual bezel movement.

16. The information handling device of claim 11, wherein the instructions are further executable by the processor to provide a visual indication of the portion of the touch sensitive surface that has been deactivated.

17. The information handling device of claim 16, wherein the portion of the touch sensitive surface that has been deactivated continues to display content.

18. The information handling device of claim 11, wherein to detect comprises detecting user supplied timing information relating to deactivation.

19. The information handling device of claim 11, wherein to detect comprises detecting assignments for two or more users for different touch input areas of the touch sensitive surface.

20. A product, comprising:
a storage device having code stored therewith, the code being executable by a processor and comprising:
code that activates, using a processor, a touch sensitive surface;
code that accepts user inputs to the touch sensitive surface;
code that detects, using a processor, a deactivation event; and
code that deactivates, using a processor, a portion of the touch sensitive surface such that the portion is unresponsive to touch input following detection of the deactivation event;
wherein the code that deactivates further deactivates one or more portions of the touch sensitive surface for one or more users; and
wherein at least one other portion of the touch sensitive surface remains active.
